(19) United States
(12) Patent Application Publication
(10) Pub. No.: US 2009/0071827 A1
(43) Pub. Date: Mar. 19, 2009

(54) METHOD AND APPARATUS TO REDUCE FALSE POSITIVE AND FALSE NEGATIVE IDENTIFICATIONS OF COMPOUNDS

(75) Inventors: Benjamin J. Cargile, Morrisville, NC (US); James L. Stephenson, Raleigh, NC (US)

Correspondence Address: OBLON, SPIVAK, MCCLELLAND MAIER & NEUSTADT, P.C., 1940 DUKE STREET, ALEXANDRIA, VA, 22314, US

(73) Assignee: RESEARCH TRIANGLE INSTITUTE, RESEARCH TRIANGLE PARK, NC (US)

(21) Appl. No.: 11/574,411

(22) PCT Filed: Aug. 31, 2005
(86) PCT No.: PCT/US2005/030935

§ 371 Date: Nov. 18, 2008

Related U.S. Application Data
(60) Provisional application No. 60/605,495, filed on Aug. 31, 2004.

(51) Int. Cl. G01N 27/26

(52) U.S. Cl. 204/452; 204/548; 204/644

(57) ABSTRACT

A method, computer program medium, and system for analyzing a protein sample that obtains a mass spectrum of the derived peptides, and determines from the mass spectrum a first set of peptide identifications for the peptides. In the method, computer program medium, and system, incorrect identifications can be filtered from the first set of peptide identifications by removal from the first set those peptide identifications ascertained to be false identifications; and the filtered first set can be filtered to generate a second set of the peptide identifications corresponding to the protein sample.

### CROSS-REFERENCE TO RELATED APPLICATIONS

The present application claims priority to U.S. Provisional Patent Application Ser. No. 60/605,495 filed Aug. 31, 2004, the contents of which are incorporated herein by reference.

### BACKGROUND OF THE INVENTION

### Field of the Invention

The invention relates to a method and apparatus to reduce false positive and false negative identifications of compounds. The present invention further relates to a method and apparatus to reduce false positive and false negative identifications of biological compounds such as peptides.

### BACKGROUND OF THE INVENTION

Typically, the process of identifying peptides within sample mixtures begins with extracting of proteins from a biological sample. After the proteins are isolated, they are digested into constituent peptides via an enzymatic reaction. The amino acid sequence within a given peptide can then be used to identify that peptide using one of several analytical techniques.

The most common approach of such techniques is that of tandem mass spectrometry (MS/MS). Tandem mass spectrometry performs two distinct stages of mass spectrometry on a given sample. One form of MS/MS used for the analysis of peptides is the product ion scan, in which, peptide molecules are ionized, individually isolated in a first stage, and then further analyzed in a second stage. Specifically, peptide ions of interest are isolated and sequentially dissociated into fragments; and then the fragments of a peptide ion currently under examination are mass analyzed in the second stage to produce a mass spectrum of intensity versus mass that can be used to identify that peptide.

In one example of identifying peptides by MS/MS, a peptide digest is simplified by separating the mixture using reverse phase liquid chromatography (RPLC). In this technique, peptides are attracted to a solid phase packing material having alkyl groups of varying chain lengths that induce peptides to preferentially bind to the column. These bound peptides can then be eluted from the column in the order of the most to the least polar peptide. As the peptide mixture elutes from the column, the peptides are ionized using an electrospray ionization source. The peptides are then transferred to the mass spectrometer, where the peptides peptides undergo mass analysis and subsequent dissociation to fragments. The fragments are then mass-analyzed as described below, to generate the product ion mass spectrum (i.e., “fingerprint”). FIGS. 1B-1E illustrate four mass spectra corresponding to four respective peptides, which were selected for the second stage mass analysis on the basis of their respective peaks in the first stage, as shown in FIG. 1A.

The second stage mass spectrum can then be used to search a variety of databases for best fit identifications of the respective peptides. There are at least two types of search algorithms used to match (i.e., “best fit”) a peptide MS/MS spectrum of a known peptide within a database to the mass spectrum of an inspected peptide. The first algorithm looks at the mass differences of the peptide fragments derived from the MS/MS experiment and generates a partial amino acid sequence that can be searched against the database. Such partial amino acid sequences, termed sequence tags, have been employed since the early 1990's. The second algorithm compares an experimentally derived MS/MS spectrum of an inspected peptide against the theoretical spectra of known peptides within a database.

FIG. 2 illustrates one application using the second algorithm, e.g., SEQUEST, which converts the character-based amino acid sequences of known peptides into respective theoretical tandem mass spectra; and compares those theoretical tandem mass spectra to an experimental tandem mass spectrum of an inspected peptide. More particularly, as shown in steps S201-S205, the second algorithm typically identifies known peptides (within a database) that approximate the measured mass of a selected peptide S202, compares the theoretical tandem mass spectra of those known peptides (which are generated in silico from the respective amino acid sequences of the known peptides) against the experimental tandem mass spectrum of the selected peptide S203, computes a correlation score (e.g., XCorr from SEQUEST) for each of the known peptides based on the degree of similarity between their respective theoretical spectra and the experimental spectrum S204, and then ranks and lists the best potential matches by correlation score S205.

The highest scoring identification for each selected peptide of the protein sample is then set aside for further verification (i.e., set aside to later determine whether the identification is correct or incorrect). A conventional method to identify peptides of a protein sample is summarized by steps S301-S307 of FIG. 3.

Verification of identifications is typically achieved by setting a correlation cutoff score. Peptide identifications lying above the cutoff are presumed to be correct identifications, while identifications lying below the cutoff are presumed to be incorrect identifications. However, some of the identifications lying above the cutoff may be false positive identifications (e.g., a high scoring identification that corresponds to a tandem mass spectrum generated from artifacts of a sample); and some of the identifications lying below the cutoff may be false negative identifications (e.g., a low scoring identification that corresponds to a tandem mass spectrum generated from the amino acid sequence of the respective peptide).

Typically, the conventional methods used to generate cutoffs result in a high number of false positive and false negative identifications. Some cutoffs are set in accordance with arbitrary recommendations of peptide identification software manufacturers. Probability based approaches are also employed to determine the appropriate cutoff scores. However, this strategy cannot account for organism specific amino acid frequencies, divergent evolutionary constraints, or the mass redundancy of amino acid combinations. Further, such approaches are frequently not as reliable as might be expected from a statistically driven approach. Another conventional method, however, determines a cutoff using a reverse database search. In a forward database search, the character-based representations of known peptides can be used to generate respective theoretical mass spectra for known peptides within a database. In a reverse database search, the amino acid sequences of the known peptides can be “reversed” to produce a “nonsense” database. Thus, the identifications that are generated by the search against the nonsense database are presumed to be entirely random; and the highest scoring identification of the reverse search is further presumed to be the greatest possible correlation score that a random identification (i.e., false positive identification) could achieve. Accordingly, the cutoff can be set at the correlation score of that best reverse identification, under the presumption that a false positive identification cannot exceed the cutoff. In a forward database search, an algorithm can be used to search tandem mass spectra against a protein database generated from the direct translation of the DNA sequence. The search results represent the best possible matches of the tandem mass spectra (true or random) to the defined protein sequences. In a reverse database search, the individual protein sequences can be translated in either reverse order or in some random fashion. This newly created database is then appended to the standard or forward database to create a single database with both forward and reverse entries. Tandem mass spectra can then be searched against this combined database. The identifications obtained give a distribution of reverse hits (in addition to the forward hits) that can be used to set a cutoff value that can effectively limit the number of false positive identifications.

As shown in FIG. 4, while this conventional method of setting a cutoff is adept at minimizing false positive identifications (solid region), it also tends to result in a substantial number of false negative identifications (shaded region). These correct identifications will be excluded and, as a result, their corresponding proteins may not be identified for the proteome under study.

### SUMMARY OF THE INVENTION

An object of the present invention is to reduce false positive and false negative identifications of biological compounds.

Another object of present invention is to reduce false positive and false negative identifications of peptides based on their isoelectric points.

Another object of the present invention is to reduce false negative and positive identifications of peptides based on a Universal Randomness Test.

Another object of the present invention is to achieve the above objects for mass-based identifications, such as MS/MS-based identifications and accurate mass-based identifications.

Still another object of the present invention is to provide a computer readable medium to implement automated methods that achieve the above objects.

Various of these and other objects are provided for in certain of the embodiments of the present invention.

In one non-limiting example, the present invention is implemented via a first method for analyzing a protein sample. The method includes: determining an isoelectric point range for a peptide derived from the protein sample by dispersing the peptide into a dispersion medium having a viscosity greater than water; obtaining a mass spectrum of the derived peptides; and identifying the derived peptide based on the mass spectrum and the isoelectric point range of the derived protein.

In another non-limiting example, the present invention is implemented via a second method for analyzing a protein sample. The method includes: determining an isoelectric point value for a peptide derived from the protein sample; obtaining a mass of the derived peptide without fragmentation of the derived peptide; and identifying the derived protein based on the mass and the isoelectric point value of the derived peptide.

In another non-limiting example, the present invention is implemented via a third method for analyzing a protein sample. The method includes: A method for analyzing a protein sample, comprising: obtaining a mass spectrum of peptides; comparing the mass spectrum of peptides against known peptide fragmentation patterns; determining from the mass spectrum of the peptides a first set of peptide identifications for the peptides; assigning to the peptide identifications peptide identification scores based on the respective comparisons between the mass spectrum and known peptide fragmentation patterns; performing a statistical evaluation of the peptide identification scores; determining a threshold value for the peptide identification scores based on the statistical evaluation; and filtering from the first set of peptide identifications those identifications having peptide identification scores below the threshold value.

In another non-limiting example, the present invention is implemented via first computer readable medium storing program instructions. The instructions cause a computer system to perform the steps of: determining from a mass spectrum of a derived peptide a first set of peptide identifications for the peptides; filtering incorrect identifications from the first set of peptide identifications by removal from the first set those peptide identifications calculated to have isoelectric point values less than or greater than an isoelectric point range.

In another non-limiting example, the present invention is implemented via second computer readable medium storing program instructions. The instructions cause a computer system to perform the steps of: determining a mass of a derived peptide without fragmentation of the derived peptides; and identifying the derived peptide based on the mass of the derived peptide and an isoelectric point of the derived peptide.

In another non-limiting example, the present invention is implemented via third computer readable medium storing program instructions. The instructions cause a computer system to perform the steps of: obtaining a mass spectrum of peptides; comparing the mass spectrum of peptides against known peptide fragmentation patterns; determining from the mass spectrum of the peptides a first set of peptide identifications for the peptides; assigning peptide identification scores, to the peptide identifications, based on respective comparisons between the mass spectrum and known peptide fragmentation patterns; performing a statistical evaluation of the peptide identification scores; determining a threshold value for the peptide identification scores based on the statistical evaluation; and filtering from the first set of peptide identifications those identifications having peptide identification scores below the threshold value.

In another non-limiting example, the present invention is implemented via a first system for analyzing a protein sample. The system includes: an isolectric point determination device configured to determine an isoelectric point range for a derived peptide of the protein sample; a mass analyzer configured to analyze a mass spectrum from the derived peptide of the protein sample; a comparator configured to compare the mass spectrum to known peptide fragmentation patterns to determine a first set of peptide identifications for the peptides; and a filter device configured to filter incorrect identifications from the first set of peptide identifications by removal from the first set those peptide identifications calculated to have isoelectric point values less than or greater than the isoelectric point range.

In another non-limiting example, the present invention is implemented via a second system for analyzing a protein sample. The system includes: an isolectric point determination device configured to determine an isoelectric point value for a derived peptide of the protein sample; a mass analyzer configured to analyze a mass spectrum from the derived peptide of the protein sample; a peptide identifier configured to identify the derived peptide based on the mass and the isoelectric point value of the derived peptide.

In another non-limiting example, the present invention is implemented via a third system for analyzing a protein sample. The system includes: an isolectric point determination device configured to determine an isoelectric point range for a derived peptide of the protein sample by dispersion of the derived peptide into a dispersion medium having a viscosity greater than water; a mass analyzer configured to analyze a mass spectrum from the derived peptide of the protein sample; a peptide identifier configured to identify the derived peptide based on the mass spectrum and the isoelectric point range of the derived peptide.

In another non-limiting example, the present invention is implemented via a fourth system for analyzing a protein sample. The system includes: a mass analyzer configured to analyze a mass spectrum from the derived peptide of the protein sample; a comparator configured to compare the mass spectrum to known peptide fragmentation patterns to determine a first set of peptide identifications for the peptides and to assign to the peptide identifications peptide identification scores based on the respective comparisons between the mass spectrum and known peptide fragmentation patterns; a filter device configured to determine a threshold value for the peptide identification scores by a statistical evaluation of the peptide identification scores, and to filter from the first set of peptide identifications those identifications having peptide identification scores below the threshold value.

### BRIEF DESCRIPTION OF THE DRAWINGS

A more complete appreciation of the invention and many of the attendant advantages thereof will be readily obtained as the same becomes better understood by reference to the following detailed description, when considered in connection with the accompanying drawings, in which like reference numerals refer to identical or corresponding parts throughout the several views.

FIG. 1A is a depiction of a mass spectrum for a first stage mass analysis of peptides.

FIGS. 1B-1E are depictions of four mass spectra, respectively, each corresponding to a second stage mass analysis of the labeled peaks in FIG. 1A.

FIG. 2 is a depiction of an algorithm to compare theoretical tandem mass spectra of known peptides with experimental tandem mass spectrum of an inspected peptide.

FIG. 3 is a depiction of a method of identifying peptides from a protein sample.

FIG. 4 is a depiction of false negative and positive peptide identifications produced by a single-criterion method of peptide analysis.

FIG. 5 is a depiction of a peptide analysis based on isoelectric points and mass spectra.

FIG. 6 is a depiction of steps of isoelectric point analysis and mass-based analysis in accord with steps S501-504 of FIG. 5.

FIG. 7 is a depiction of a plot of peptide identifications.

FIG. 8 is a depiction of the plot of FIG. 7 with a conventional correlation cut-off score.

FIG. 9 is a depiction of the plot of FIG. 8 with a pI filter and new correlation cut-off score.

FIGS. 10A, 11A, 12A, and 13A are depictions of four mass spectra, respectively, of derived peptide type samples.

FIGS. 10B, 11B, 12B, and 13B are depictions of four data tables, respectively, corresponding to the mass spectra of FIGS. 10A, 11A, 12A, and 13A.

FIG. 14 is a depiction of a peptide identification plot including a URT cut-off score.

FIG. 15 is a depiction of a general purpose computer or microprocessor.

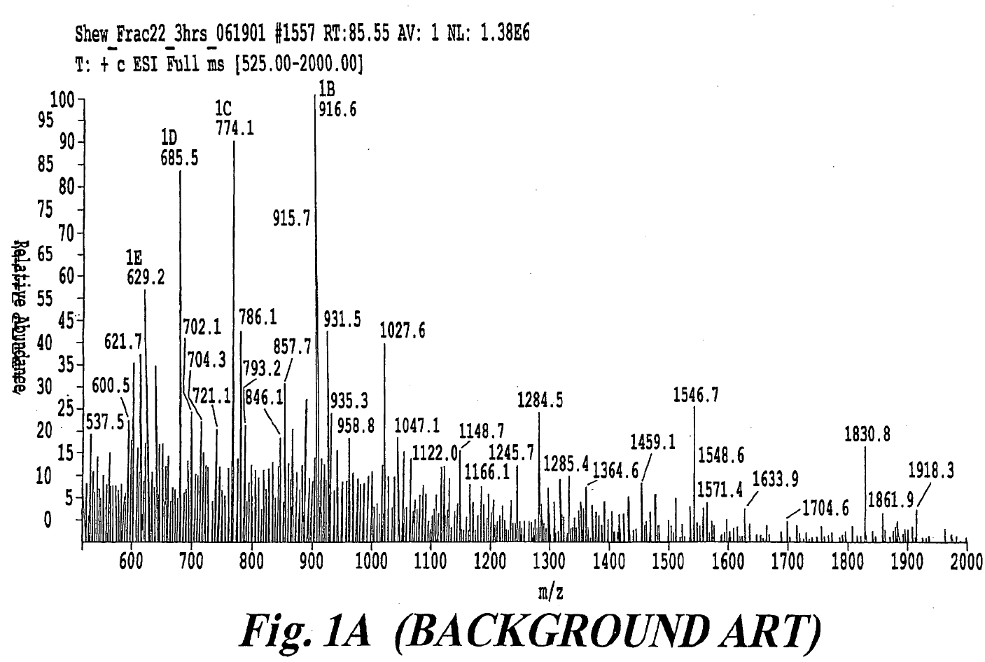

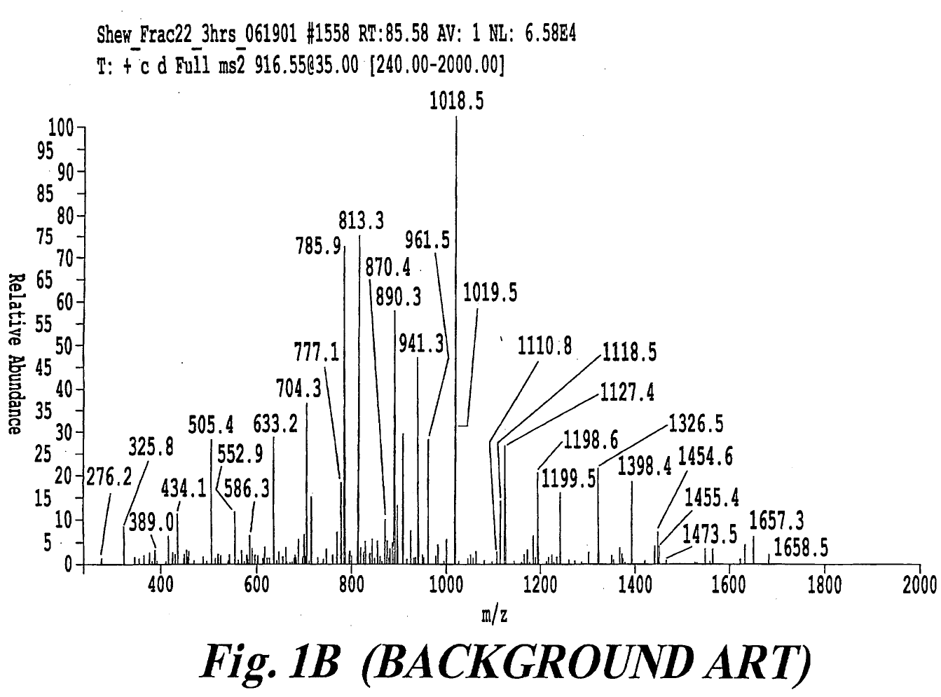

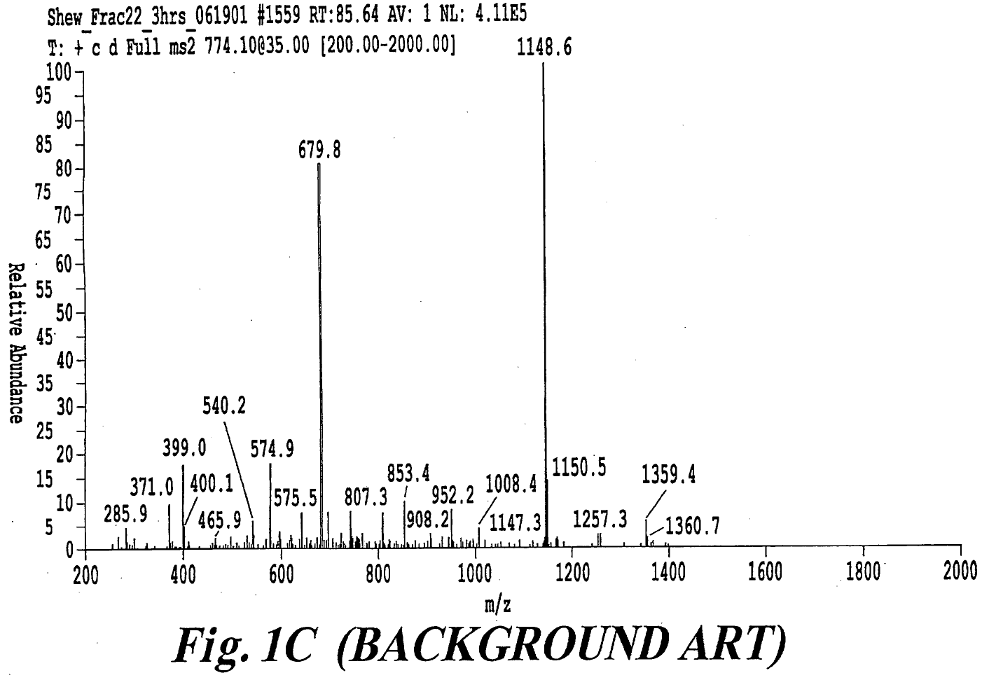

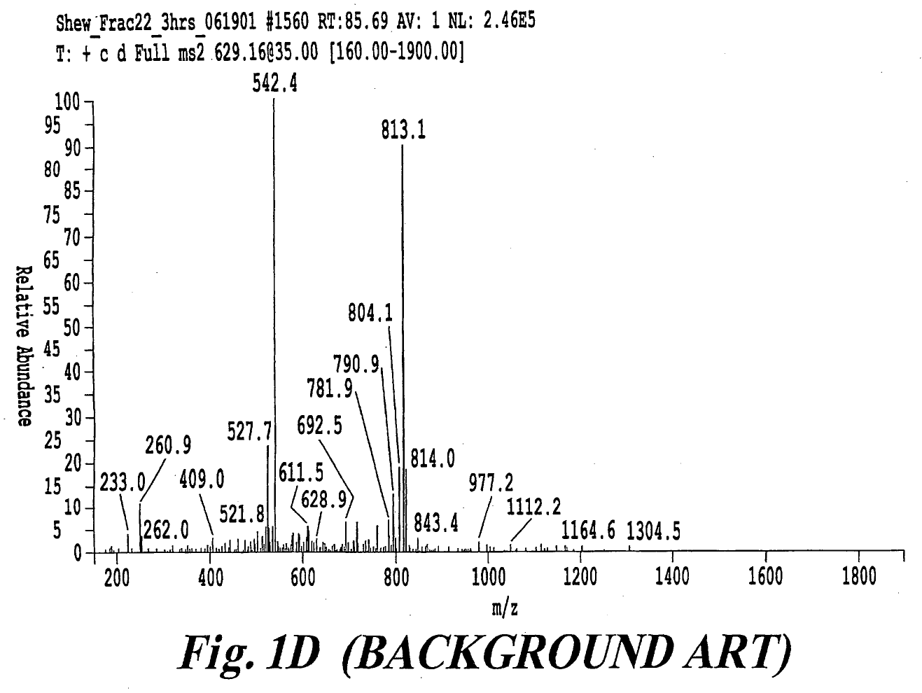

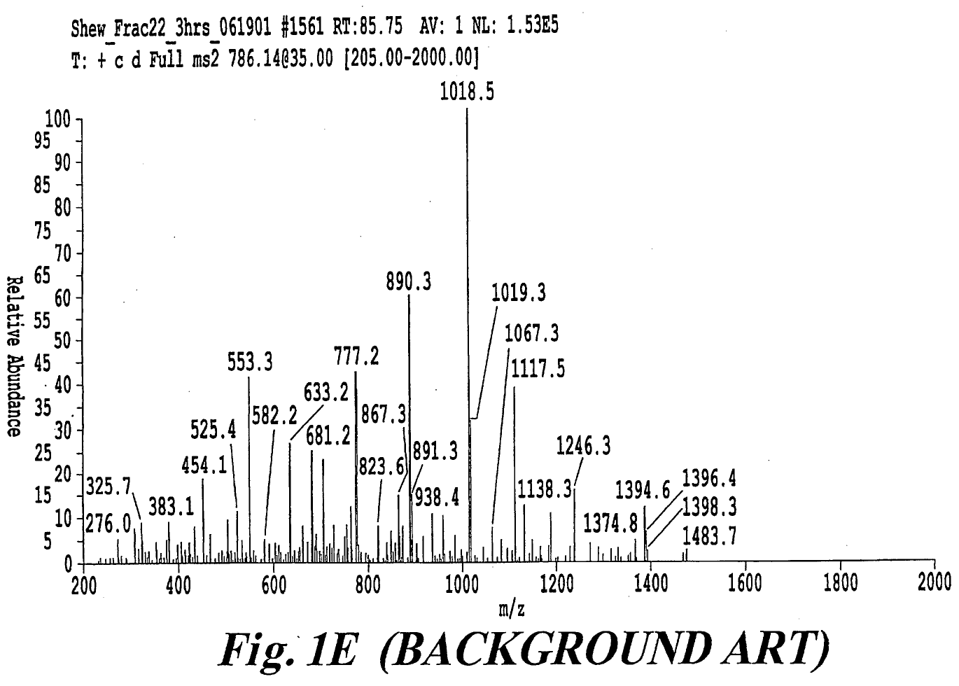

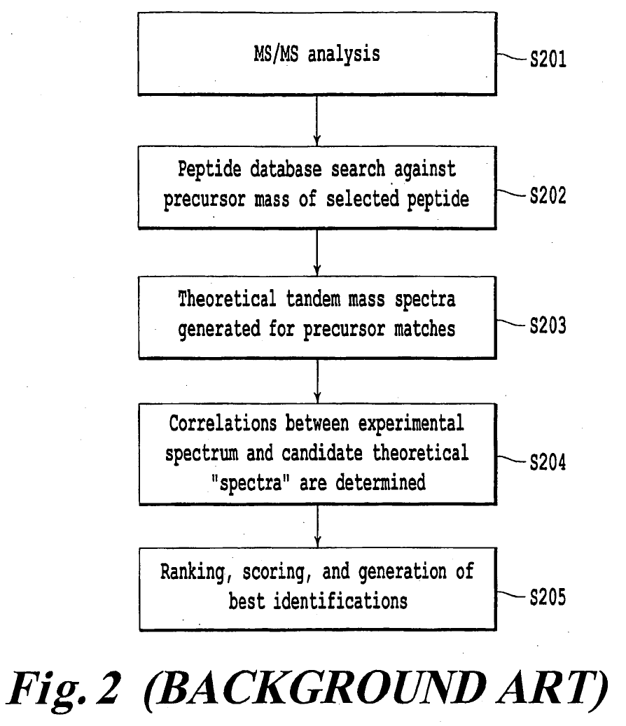

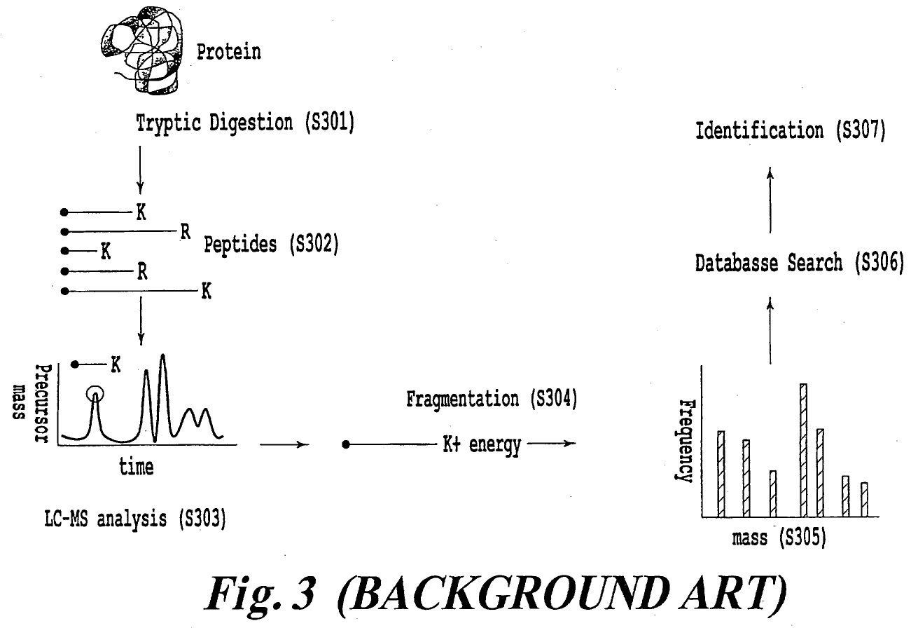

### DETAILED DESCRIPTION OF THE PREFERRED EMBODIMENTS

Referring now to the drawings, wherein like reference numerals designate identical or corresponding parts throughout the several views the following description includes a non-limiting disclosure of the various embodiments of the present invention.

### First Embodiment

As noted, an object of the present invention is to reduce false negative and false positive identifications of compounds; and to reduce false negative and false positive identifications of peptides based on their isoelectric point (pI) values. More particularly, the present invention can use in various embodiments the experimental pI range of peptides within a sample of interest as a second criterion for identification. For example, in the embodiments discussed below, the experimental pI range of peptides within a sample subjected to mass analysis is used to remove identifications that correspond to known peptides having respective pI values outside the estimated pI range.

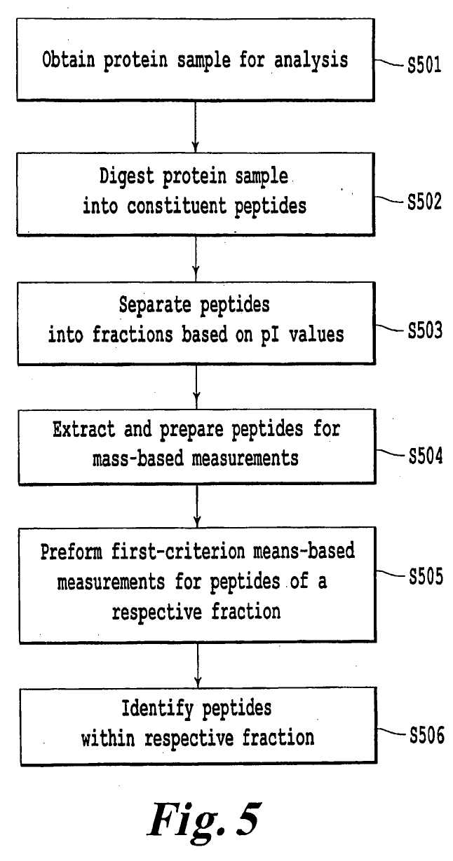

FIG. 5 is a flowchart illustrating one example of specific steps used to generate and filter mass-based peptide identifications in accord with the first embodiment of the present invention. The steps described with reference to FIG. 5 are based, in part, on a work by some of the present inventors, showing the effectiveness of isoelectric focusing for generating and filtering peptide identifications of a common laboratory rat proteome (Essader, A. S.; Cargile, B. J.; Bundy, J. L.; Stephenson, Jr., J. L., A Comparison of Immobilized pH Gradient Isoelectric Focusing and Strong Cation Exchange Chromatography as a First Dimension in Shotgun Proteomics, Proteomics 2005, 5, 25-34; entire contents of which are incorporated by reference).

In the field of proteomics, one parameter for identification and characterization of peptides and proteins is isoelectric point (or pI value). The pI value can be defined as the point in a titration curve at which the net surface charge of a protein or peptide equals zero. This value has implications in the field of isoelectric focusing (IEF) where the focusing effect of the electrical force is counterbalanced by diffusion. As a protein or peptide diffuses from its steady state position it becomes charged and migrates back to the place where the net charge (and mobility) equals zero. Since peptides and proteins in a defined pH gradient will remain focused at their pI value by application of an electric field, high resolution separations can be achieved on a routine basis.

Currently, a solution phase pH gradient (IPG) IEF is one high resolution electrophoretic separation methodology available for analysis of peptides and proteins. For instance, Free Flow Electrophoresis (FFE) is an electrophoresis procedure working continuously in the absence of a stationary phase (or solid support material such as a gel) to separate preparatively charged particles ranging in size from molecular to cellular dimensions according to their electrophoretic mobilities (EPMs) or isoelectric points (pIs). Samples are injected continuously into a thin buffer film, which may be segmented or uniform, flowing through a chamber formed by two narrowly spaced glass plates. Current may be applied perpendicularly to the electrolyte and sample flow, while the fluid is flowing (continuous FFE) or while the fluid flow is transiently stopped (interval FFE). In any case, the applied electric field leads to movement of charged sample components towards the respective counterelectrode according to their electrophoretic mobilities or isoelectric points. The sample and the electrolyte used for a separation enter the separation chamber at one end and the electrolyte containing different sample components as separated bands is fractionated at the other side.

Immobilized pH gradient (IPG) IEF is another high resolution electrophoretic separation methodology available for analysis of peptides and proteins. One application of IPG technology is as a first dimension separation method in 2-D gel electrophoresis.

As shown illustratively in FIG. 5, step S501 obtains a protein sample for analysis. For example, in the Comparison Study, samples can be prepared by dissecting a nominal mass (0.2 g) of frozen rat testis, followed by solubilization in a lysis buffer consisting of 8 M urea in 50 mM Tris-HCl, pH 8.0. The suspension can be vortexed for 10 minutes and exposed to three freeze-thaw cycles. After centrifuging the sample for 30 minutes at 25,000 g at 4° C., the aqueous phase can be removed and its protein concentration can be determined by a BCA assay (PIERCE, Rockford, Ill.). One milligram of sample lysate can be reduced with 10 mM DTT and heating at 37° C. for 1 hour. The urea concentration can be diluted to 1 M by the addition of digestion buffer (1 mM CaCl₂ and 50 mM Tris-HCl pH 7.6).

Next, in step S502, the protein sample is digested into its constituent peptides using, for example, an appropriate protease. For instance, twenty micrograms of sequencing grade trypsin (PROMEGA, Madison, Wis.) are added to the sample for digestion at 37° C. overnight (˜18 hours). The digested sample is desalted with a C18 SEP-PAK (WATERS, Milford, Mass.) following the manufacturer's procedure. The peptides eluted off the SEP-PAK are evaporated to dryness in a SPEEDVAC and then re-suspended using 8 M urea and 0.5% carrier ampholytes (AMERSHAM BIOSCIENCES, Piscataway, N.J.) for IPG fractionation.

After digestion, in step S503, the peptides are separated into fractions based on their pI values. The present inventors have determined that gel based IEF holds significant advantages over other techniques that may be used to fraction peptides based on pI value (see Benjamin J. Cargile, Jonathan L. Bundy, Thaddeus W. Freeman, and James L. Stephenson, Jr., Gel Based Isoelectric Focusing of Peptides and the Utility of Isoelectric Point in Protein Identification, Journal of Proteome Research 2004, 3, 112-119; hereinafter “Gel Based IEF Study”; entire contents of which are incorporated herein by reference). The inventors have further determined that narrow range immobilized pH gradient (NR-IPG) IEF holds additional advantages over wider range gel based IEF.

The gel based approach (known as IEF) was the first high resolution separation technique developed for fractionation of proteins or peptides in a high resolution format (se the brief description of IEF above). One difference between IEF and what is termed IPG is the fact that with IPG strips, the pH gradient can be preformed. A pH gradient is “immobilized” onto the gel. In “regular” gel electrophoresis in which these experiments were first performed, that pH gradient was not preformed. In the gel based approach, carrier ampholytes which create a pH gradient (once the voltage is turned on) are added. Typically, one can prefocus the gradient before the sample is added. These experiments were performed using the gel based approach because it was a familiar technique. The approach works much better with IPG.

One advantage of IEF techniques in general is the fact that high resolution separation of compounds can be achieved based on a known physiochemical property of that compound, in this case pI or isoelectric point. The advantages of IPG over gel IEF with carrier ampholytes include: higher loading capacity; better resolution; better mechanical stability; less sensitive to interferences; less pH drift associated with long focusing times; and less sensitive to temperature fluctuations. The advantages of using NR-IPG (i.e pH 3.5-4.5) or narrow range gradients over wide range (pH 3-10) strips are as follows: increased resolution or separation (which automatically improves the pI prediction); and higher loading capacity.

In IPG-IEF, a peptide sample is placed in an immobilized pH gradient strip. The peptide becomes negatively charged, positively charged, or uncharged, depending upon the local pH and the peptide's characteristics (e.g., amino acid sequence). Upon application of a voltage potential, the peptide (if charged) migrates through the pH gradient toward the anode or cathode. As the peptide migrates through the pH gradient, the peptide eventually encounters a local pH corresponding to its characteristic pI. At that point, the now focused peptide loses its charge and ceases to migrate under the influence of the electric field. The local pH at which this occurs is the pI of the peptide. The IPG gel strip is excised into IGP gel sections of respective pH ranges (i.e., fractions). As suggested above, a focused peptide that is located within a particular IGP gel section should have a pI value within the respective pH range of that section.

After a sample digest is re-suspended in 8 M urea, the sample digest can be prepared for IPG-IEF loading according to manufacturer's (AMERSHAM BIOSCIENCES, Piscataway, N.J.) protocol for narrow pH range (3.5-4.5) IPG strips, by the addition of a pH 3.5-4.5 ampholyte solution. The IPG strip can be re-hydrated for 10 hours and then can be focused overnight using the following program, for example: 1 hour at 500 volts, 1 hour at 1000 volts, and 7.5 hours at 8000 volts with all steps programmed in volt hours rather than time. One focusing unit suitable for these experiments is ETTAN IPGPHOR II (AMERSHAM BIOSCIENCES, Piscataway, N.J.).

In step 504, after the peptides are separated by their pI values, the peptides are extracted and prepared for mass-based measurements. At the end of the IPG focusing process, the 18-cm long gel strip can be sliced into 43 sections, with each section being stored in a separate 1.5-mL microcentrifuge tubes. To all tubes, 150 μL of a 0.1% TFA (trifluoroacetic acid) solution was added to extract the peptides. Each tube (gel section) was vortexed for 10 minutes followed by sonication for an additional 10 minutes. The resulting peptide solutions can be then transferred to separate centrifuge tubes. This extraction process step can be then repeated two more times using 50% ACN (acetonitrile), 0.1% TFA, and 100% ACN, 0.1% TFA, and the resulting peptide solutions from these extractions were combined with those from the initial extraction. The 450 μl combined peptide extract solutions can be then evaporated to dryness using a SPEEDVAC (THERMO ELECTRON CORPORATION, Franklin, Mass.).

Further, each dried fraction can be re-suspended in 0.1% TFA and desalted using in-house constructed C18 spin columns made by using 0.2-μm spin filters (PALL LIFE SCIENCES, East Hills, N.Y.) with C18 media (ALLTECH, State College, Pa.). Peptides desalted on the spin columns were eluted with a 300 μL ACN solution. After another evaporation step, the samples were re-suspended in a 15 μL 0.1% TFA solution and were sonicated for 10 minutes. This was followed by a brief centrifugation step for 15 seconds to remove any remaining C18 particles. Peptide analysis was then completed by LC-MS/MS.

Next, in step S505, mass-based measurements are performed upon the separated peptides of a particular fraction. Those mass scan measurements may be taken by numerous MS analysis techniques, such as MS/MS, or a “accurate mass” approach, a time-of-flight mass spectrometer, a quadrupole mass spectrometer, a Fourier transform ion cyclotron resonance mass spectrometer, an ion trap mass spectrometer, or by a hybrid instrument technique such Q-TOF, LTQ-FTMS, TOF-TOF, and accurate mass triple quadrupoles.

In the mass accurate approach, the mass of a peptide is determined with such accuracy, such that a second stage mass spectrum is not determined. The present inventors have determined that the accurate mass approach is a viable technique for peptide identification when coupled with pI filtering (see Benjamin J. Cargile and James L. Stephenson, Jr., An Alternative to Tandem Mass Spectrometry: Isoelectric Point and Accurate Mass for the Identification of Peptides, Anal. Chem. 2004, 76, 267-275, published on web Dec. 29, 2003; hereinafter “Accurate Mass Study”; entire contents of which are incorporated by reference).

What is commonly termed the accurate mass approach is by definition searching for peptide identifications with only the mass of the intact peptide (i.e. before MS/MS). The basic principle is that if the mass accuracy of the intact is good enough (typically better than 3 parts per million) then all peptides can be identified by their unique mass. In practice, however, any proteins have redundant sequences which precludes the ID of any one protein. Also, peptides with the same amino acid composition but different sequences cannot be distinguished. From a database standpoint, the more proteins one has, the more difficult it becomes to perform accurate protein identification by accurate mass technique. Therefore, most of the work in accurate mass study has been done with small genomes (i.e. bacteria) and not with more complex organisms like humans. pI is one property that can be predicted with enough accuracy to significantly improve the accurate mass approach.

The mass-based measurements can be performed by liquid chromatography MS/MS (LC-MS/MS). The LC-MS/MS system can include an LCQ DECA XP PLUS ion trap mass spectrometer (THERMO ELECTRON CORPORATION, San Jose, Calif.) interfaced to PICOVIEW MODEL PV-500 electrospray ionization source (NEW OBJECTIVE, Woburn, Mass.), and an LCPACKINGS ULTIMATE PUMP, SWITCHOS column switching device and FAMOS AUTOSAMPLER (DIONEX CORPORATION, Sunnyvale, Calif.). A 10-cm long 75 μm i.d. column can be packed with monodisperse 5 μm polymeric small bead RPC medium column packing material (SOURCETM 5RPC, AMERSHAM BIOSCIENCES, Piscataway, N.J.). Peptides can be analyzed using a 135 minute gradient from 10% to 50% solvent B (solvent A: HPLC grade water with 0.1% formic acid; solvent B: 70% ACN with 0.1% formic acid) at a flow rate of 250 nL/min. The mass spectrometer can be set up to acquire one full MS scan, in the scan range of 400-1500 m/z, followed by three MS/MS spectra of the three most intense peaks.

In step S506, measurements are analyzed to identify peptides within a respective target fraction. Conventional MS analysis software, such as SEQUEST, can be employed to generate peptide identifications in the manner described in the “Background of the Invention”.

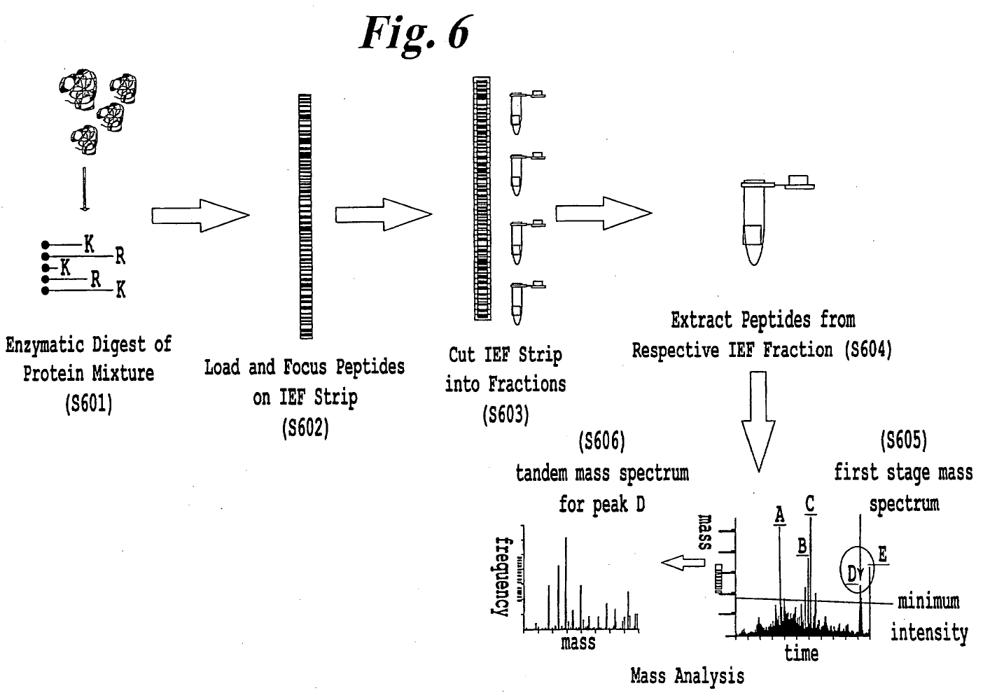

FIG. 6 provides exemplary steps S601-606 for performing mass based peptide identification. In FIG. 6, the proteins of a sample are digested into peptides (S601) having, in this example, lysine and arginine C-terminus ends. The lysine and arginine ends result from the use of trypsin for protein digestion. As should be apparent to one skilled in the art, the present invention may employ other proteases for digestion. The peptides of the digested sample can be focused on an IEF strip (S602), which is then cut into sections (S603). The peptides can be extracted from those sections to generate fractions having respective pH ranges (S604).

In FIG. 6, one such fraction is then subjected to LC-MS/MS. As the peptides of the fraction are subjected to the first stage of MS analysis (S605), peptides corresponding to mass peaks A-D exceeding a prescribed minimum intensity can be sequentially subjected to the second stage of MS analysis to generate respective tandem mass spectrums for those mass peaks (S606). In this example, tandem mass spectra have already been generated for mass peaks A, B, and C (not shown); a current tandem mass spectrum is generated for mass peak D (shown); and a tandem mass spectrum for peak E (not shown) awaits to be generated. The tandem mass spectra of peaks A-E are stored and eventually used to generate peptide identifications.

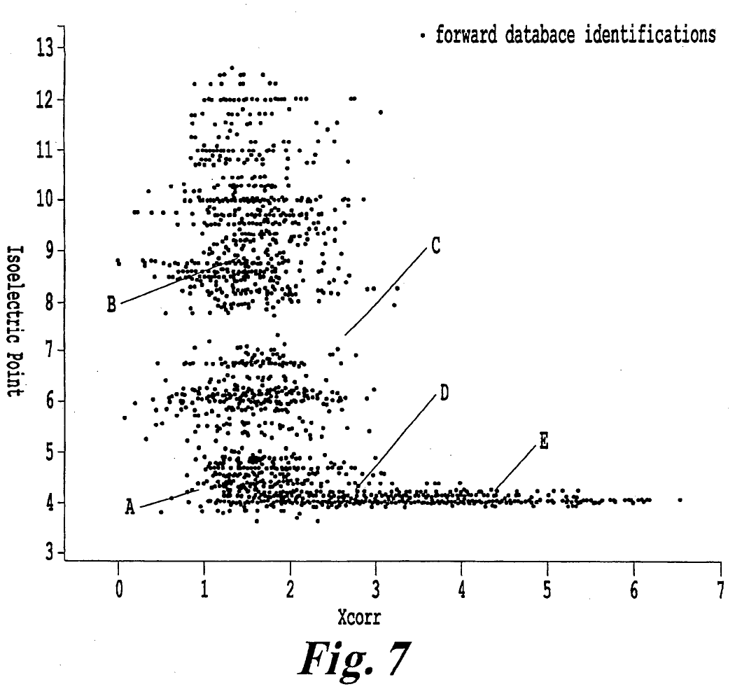

FIG. 7 is an expanded view of a plot showing peptide identifications generated from a pI-based fraction. In this example, the identifications are conventionally generated via a forward database search. However, as should be apparent to one skilled in the art, there are various methods by which the identifications may be generated. As shown, identification B, which corresponds to the tandem mass spectrum of peak B from FIG. 6, identifies a peptide having a pI value greater than the peptides corresponding to the tandem mass spectra of peaks B-E. Identification E, which corresponds to the tandem mass spectrum of peak E from FIG. 6, identifies a peptide having a correlation score (e.g., XCorr) value greater than the peptides corresponding to the tandem mass spectra of peaks A-D. Of course, some of the identifications shown in FIG. 7 are incorrect. The present invention is provided, in part, to remove those incorrect identifications.

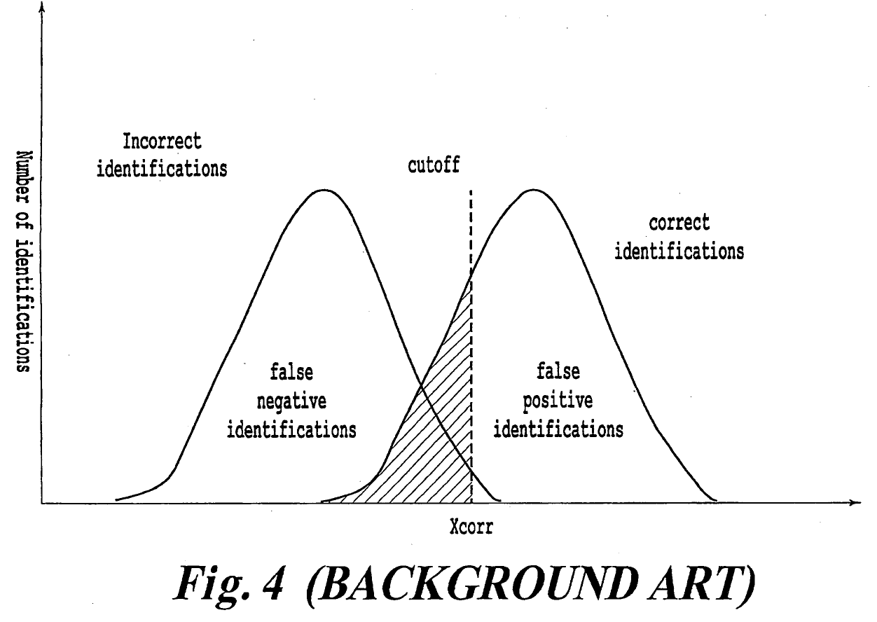

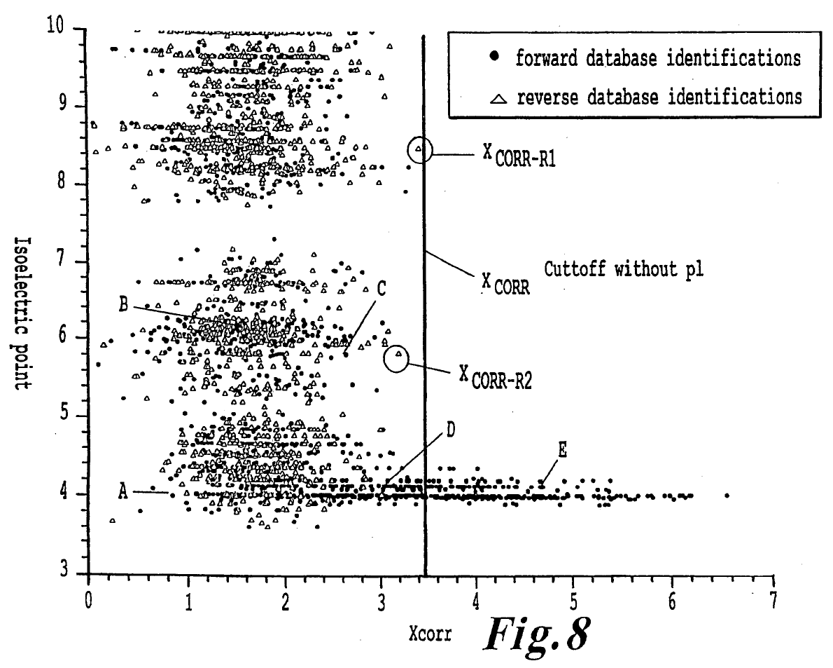

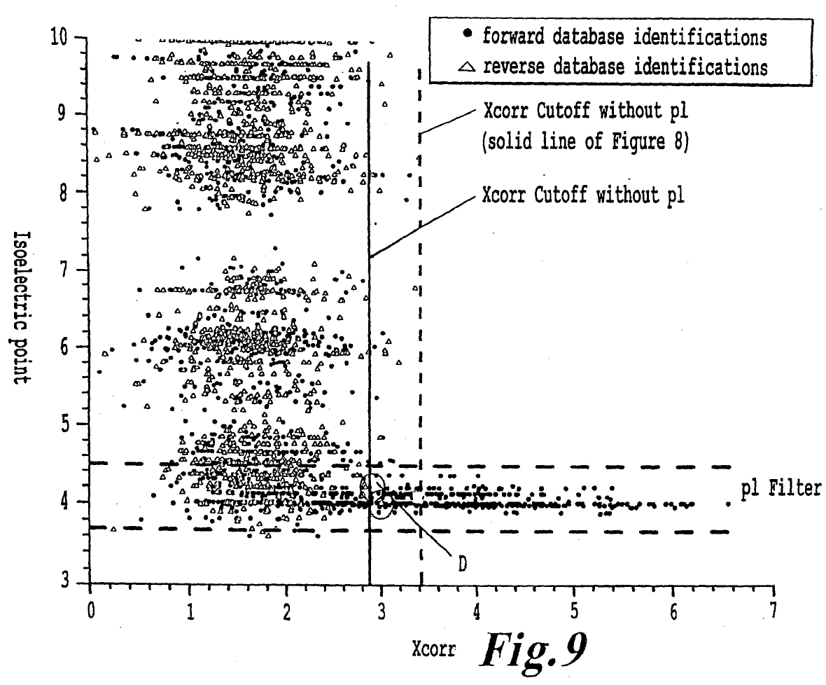

As shown in FIG. 8, a conventional cutoff score (solid line) may be determined using the highest scoring identification of a reverse database search, which in this instance is XCorr_{R1}; or possibly another high scoring identification of a reverse database search, such as XCorr_{-R2}. However, as discussed, such a conventional cutoff score will likely result in a substantial number of false negative identifications (see FIG. 4).

Accordingly, a pI filter of the present invention can be used to formulate a better correlation score cutoff. Clearly, only those identifications that correspond to peptides having pI values within the pH range of an examined fraction (plus or minus some degree of error; see discussion below) should be regarded as correct identifications, because a peptide having a pI value outside of that pH range should not be found within that fraction (e.g., should not be focused, during IPG-IEF, into the IPG section corresponding to that fraction).

Therefore, as shown in FIG. 9, the pI filter can retain only those identifications that correspond to peptides having pI values within the pH range of an inspected fraction (see those hits bracketed by the dashed horizontal lines in FIG. 9). The respective pI values are calculated from the amino acid sequences of those identified peptides, via conventional methods. Once the forward and reverse database identifications that correspond to peptides having pI values outside the pH range of an inspected fraction are determined, those identifications can be removed from consideration and a better correlation cutoff score that accounts for pI value (hereinafter “pI assisted cutoff”) may be generated.

In this example, the chosen pI assisted cutoff (dashed line in FIG. 9) is the correlation score of the highest reverse database identification within the pI filter's range, and is not the unassisted cutoff (solid line of FIGS. 8 and 9). It is noted, however, if the pI assisted cutoff was to be placed at the best reverse identification XCorr_{-R1-pI}, then the false positive rate for that pI assisted cutoff would be very similar to the false positive rate of the conventional cutoff of FIG. 8 (i.e., a nearly 0% false positive rate). However, the pI assisted cutoff retains a substantially greater number of potentially correct identifications (since only those identifications within the pI filter range can be correct). Thus, the pI assisted cutoff provides more sensitive filter than the conventional cutoff, without increasing the false positive rate. In this instance, identification D is one of the various identifications retained as a result of the pI assisted cutoff.

The pI range of the peptides within a given fraction may be experimentally determined from the conditions and results of the separation technique. As noted above, at least because of its high resolution and reproducibility, IPG-IEF lends itself to such an experimental determination. That resolution can be further increased when a narrow range IPG strip is used.

Alternatively, the pI filter range may be calculated from the pI values of the peptides identified for that fraction (e.g., by calculating the average and standard deviation of the pI values for those identifications). Some of the identifications may be removed from that calculation to increase the reliability of the pI filter range. For instance, to address potential cross-contamination between IPG sections, an identified peptide may be removed from consideration if it was also identified in a prescribed number of other fractions (e.g., more than three other fractions).

### Second Embodiment

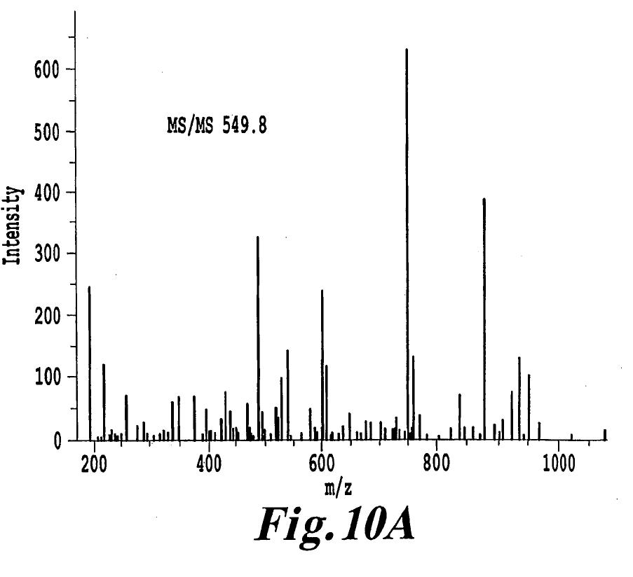

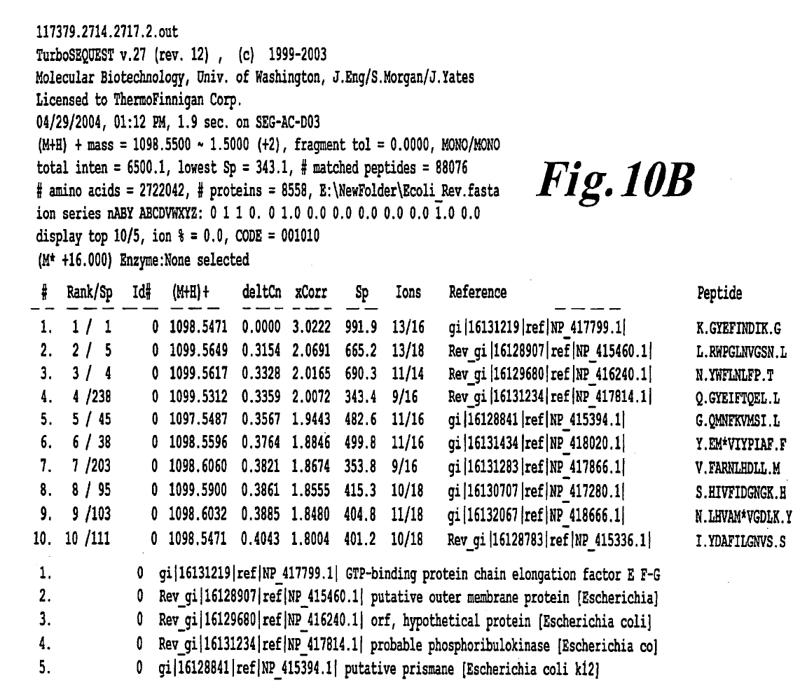

FIGS. 10A, 11A, 12A, and 13A are four examples of mass spectra taken from derived peptide samples. FIGS. 10B, 11B, 12B and 13B are tables including the data of FIGS. 10A, 11A, 12A, and 13A, respectively. The following discussion is complementary and not limited to the pI based approach. More particularly, as further explained below, the following findings were verified via the application of a pI filter.

The first mass spectrum shown in FIG. 10A shows a typical mass spectrum for a mass range of 200-1200 amu and displays a number of prominent peaks. The data correlation predicts that the peptide in the mass spectrum is most likely K.GYETINDIK.G with a correlation score of 3.022, a respectable number. The match at the second best “peptide match” is a match found from the reverse search. A high correlation value for the reverse search hit suggests that random matching could be a problem for this data set.

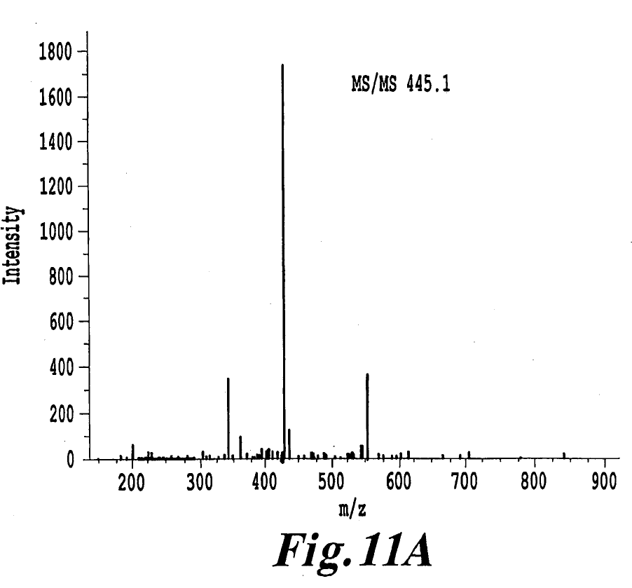

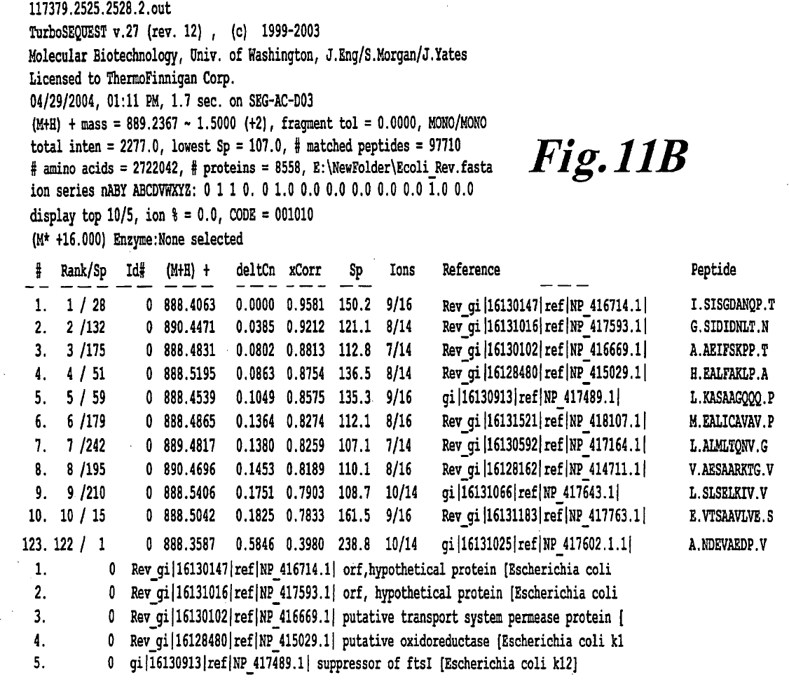

Compare this result to the results in FIG. 11A where now the intensity counts are higher than that in the mass spectrum of FIG. 10A, suggesting a more reliable data set. However, the highest XCorr values are associated with reverse data base matches. Further, the XCorr values here of approximately 1.0 indicate that the spectrum is one of low confidence despite the high signal to noise data. Furthermore, the top “hits” shown for the reverse search corroborate the low confidence.

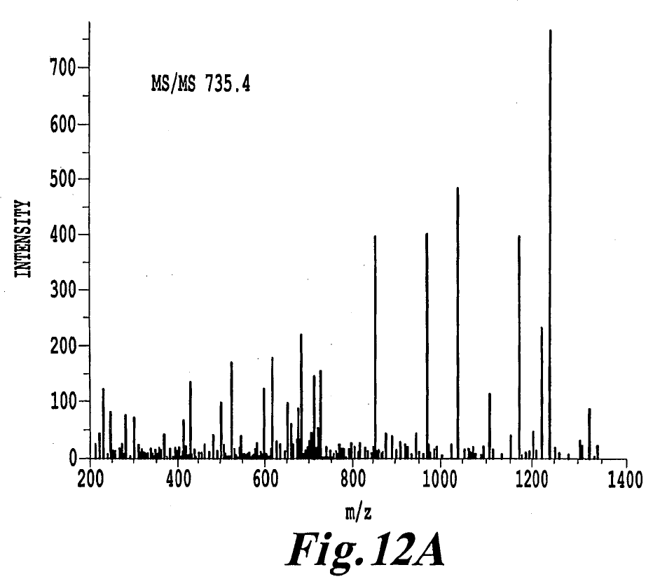

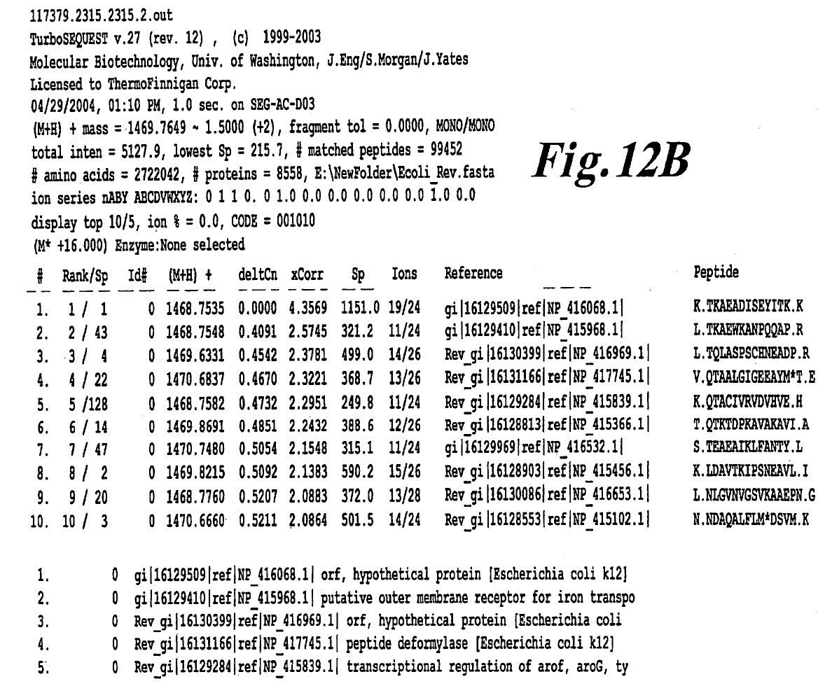

The mass spectrum in FIG. 12A shows a highly fragmented mass spectrum. The high number of fragments produces a reliable best match indicated by the XCorr value of 4.3569. While a number of reverse matches are found, the next best match of 2.5745 is not clustered with the best match, suggesting the best match is reliable.

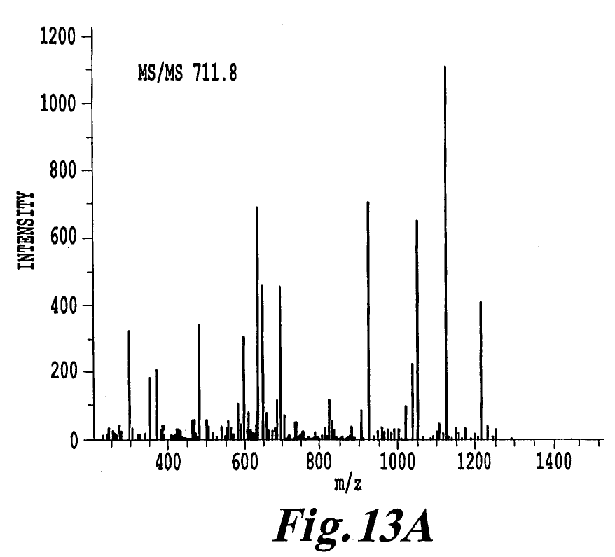

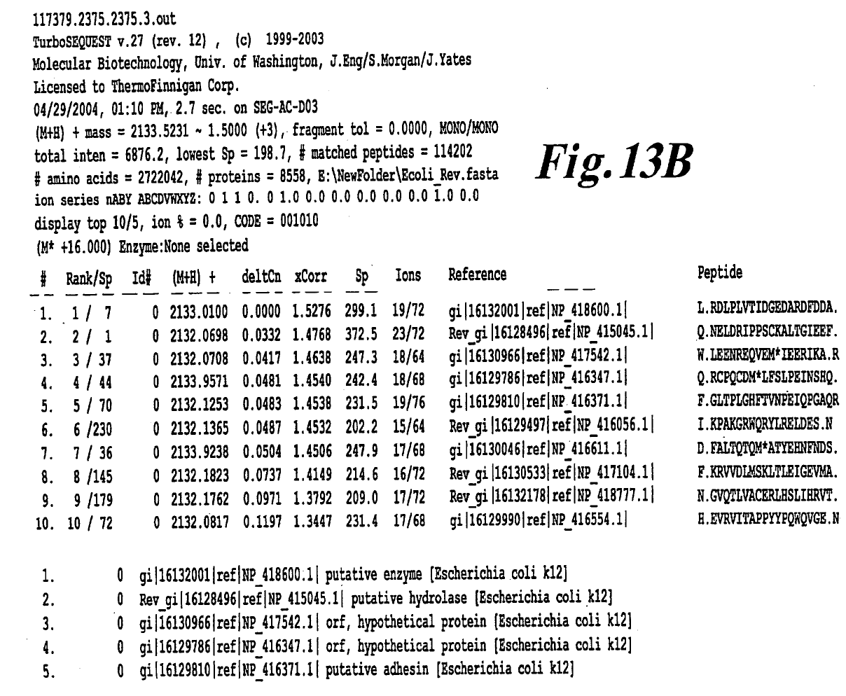

The last spectrum shown in FIG. 13A shows a well-fragmented mass spectrum having a reasonable signal-to-noise ratio. Without data analysis, one might expect the data to be reliable. However, the XCorr values show a low correlation score and high clustering for the best match.

In view of the subjectivity and tediousness of manually inspecting mass spectra, even for well fragmented samples generating a reasonable signal-to-noise ratio, statistical data analysis using large sets of data is desirable. Such analysis can potentially provide a basis for a purely mathematical filtering technique. However, a filtering technique would be more dependable if correlations between the mathematically derived results and physically derived results, e.g., pI values, can be shown.

The present inventors have accordingly used the pI filtering technique in conjunction with statistical data analysis to evaluate statistical filtering techniques. In one study in which the pI filtering technique is employed, the standard deviation (STD) score of equation (1) was shown to be less reliable than the Universal Randomness Test (URT) score of equation (2), whereby

$$\begin{matrix}S T {D}_{Corr} = \frac{{XCorr}_{1} - \overline{{XCorr}_{2 - 9}}}{{σ}_{{XCorr}_{2 - 9}}} & ( 1 ) \\ U R T = \frac{{XCorr}_{1}}{\overline{{XCorr}_{2 - 9}}} & ( 2 )\end{matrix}$$

This URT score was shown to be particularly adapted to reduce false negative identifications. X̅C̅o̅r̅r̅₂̅₋̅₉̅ is the average of the nine closest correlation values to XCorr1. The present invention is not limited to nine XCorr values. Sets of three, six, nine or more can be used.

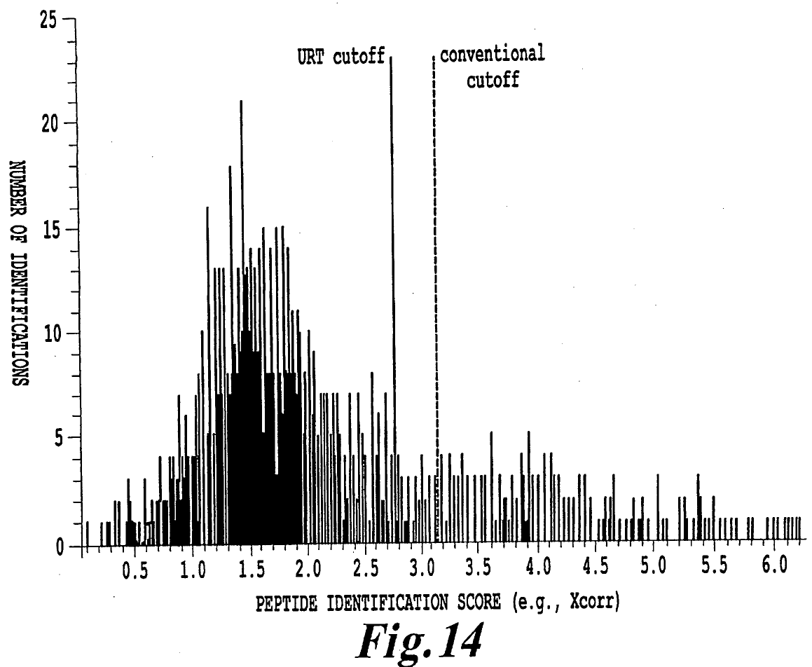

FIG. 14 shows an application of a URT score filter. More particularly, FIG. 14 plots the frequency of forward database identifications as a function of their respective correlation scores (e.g., XCorr). FIG. 14 also shows the placement of a conventional cutoff. In this example, the conventional cutoff is based on the highest scoring reverse search identification. Such a high reverse hit score can occur on occasion.

For reasons explained above, the conventional cutoff produces a significant number of false negative identifications. Accordingly, the inventors studied the STD and URT filter to generate an improved cutoff. As noted above, the viability of both the STD and URT filter were verified against the pI filter. In other words, the two criterions of the pI filter (i.e., pI value and amino acid sequence) were determined to produce less false negative identifications than the conventional cutoff based on a highest (or even next highest, etc.) reverse search score. Consequently, the pI filter can be used as a benchmark to judge the viability of new cutoff techniques relying strictly on amino acid sequence and consequently can be used with new statistical techniques to eliminate false positives. More particularly, the STD and URT filter values were assessed in view of their similarity to the pI filter value.

Both the STD and URT filter were shown to produce less false negative identifications than the conventional cutoff based on a highest reverse search score. However, the URT filter represents a significant improvement over the STD filter, for at least two reasons. The URT score calculation can be less sensitive to second or third place peptide identifications that are not clustered with the random (i.e., reverse search) hits. Such a condition can drive the STD score artificially low (i.e., produces more false positive identifications) by increasing the value in the dominator. By calculating an average value, the URT score can reduce this effect on the value in the denominator.

Accordingly, in instances of high sequence homology for example, the URT values come closer to a true cutoff value (i.e., less false positive identifications). In any type of pattern matching approach to data analysis, whether it is mass spectrometry related or not, there are a certain amount of random matches between similar patterns that are not exactly the same. The URT scoring system can discriminate between these random and nonrandom matches. More particularly, if the best match scores significantly higher than the other matches, then the top match is likely to be significantly better than a random match. Conversely, if the best match scores close to the same correlation score as other matches, then the top match is likely to be a random hit. For the case where there is significant peptide sequence homology between the first and second hits, the URT score more accurately represents this scenario since the average of XCorr₂₋₉ in the denominator is not affected to the same degree as the standard deviation in the STD score. The URT score can be considered to be at the level of the single pattern matching search such as comparing a single tandem mass spectrum to the database.

A fidelity score can be used once a large number of tandem mass spectra and associated scores (URT, XCorr, Ions Score, etc.) have been assigned. Fidelity score can measure how far above the background tandem mass spectra that a top match is with respect to the tandem mass spectra that are true matches. The higher the score (for the true hit) is above the random matching noise, the more likely that the true hit has been assigned correctly. The fidelity score may be defined as follows in equation (3):

$$Fidelity Score = \frac{{X}_{corr 1} - Highest Reverse hit}{Highest Reverse hit} \qquad ( 3 )$$

The data generated from the above steps may be provided to a reporter unit and/or tandem Bio-interpreter. The reporter unit can compile different results from the multiple analyses of the present invention. For instance, the reporter unit may compile a list of respective peptides and corresponding proteins for all identifications. In addition to the fidelity score for all peptides, the reporter may also include a fidelity score for the corresponding proteins, which can be derived from by simply summing the fidelity scores of the respective peptide identifications. Further, the reporter may include the pI and URT cutoff information.

The Bio-Interpreter can provide varied biological information pertaining to those results. For instance, the MS Bio-lnterpreter may link (e.g., hyperlink) identified peptides and corresponding proteins with their COG (Cluster Orthogolus Groups of Proteins) identification, SwissProt information, and enzymatic pathway information (as provided from the KEGG database and NCBI). In addition, the MS Bio-lnterpreter may summarize protein lists into various enzymatic pathways that allow a user to determine which pathways and categories of proteins are utilized by the particular cell under study.

### Computer Implementation

This invention may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

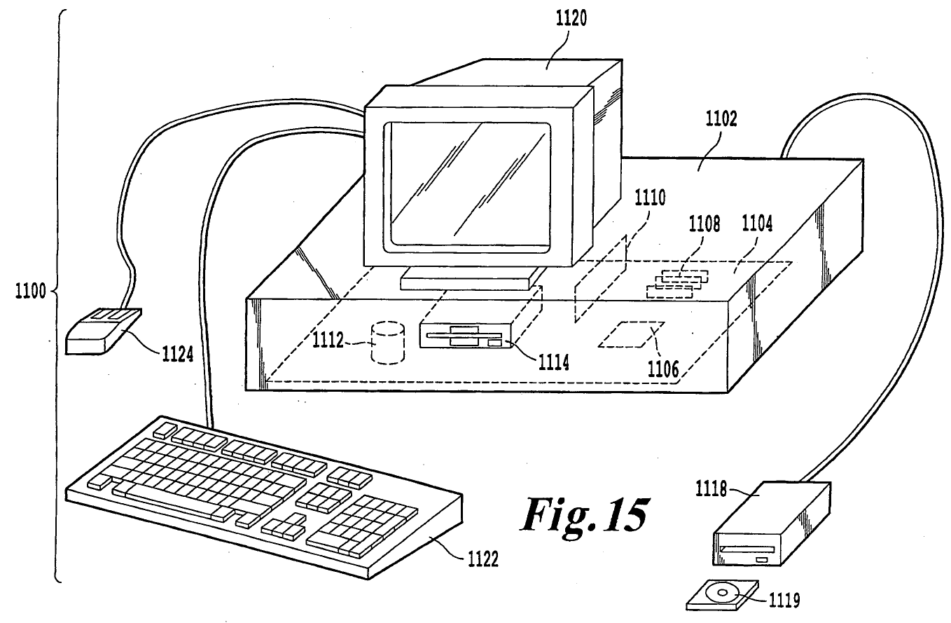

A non-limiting example of a computer 1100, as shown in FIG. 15, may be used to implement any of the methods of the present invention, wherein the computer housing 1102 houses a motherboard 1104 containing a CPU 1106, memory 1108 (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer 1100 also includes plural input devices, (e.g., keyboard 1122 and mouse 1124), and a display card 1110 controlling a monitor 1120. The computer 1100 can be used to drive any of the devices listed in the appended claims such as for example the disclosed isolectric point determination device, the mass analyzer, the peptide identifier, and the comparator, among others.

Additionally, the computer 1100 may include a floppy disk drive 1114; other removable media devices (e.g. compact disc 1119, tape, and removable magneto-optical media (not shown)); and a hard disk 1112 or other fixed high density media drives, connected via an appropriate device bus (e.g., a SCSI bus, an Enhanced IDE bus, or an Ultra DMA bus). The computer may also include a compact disc reader 1118, a compact disc reader/writer unit (not shown), or a compact disc jukebox (not shown), which may be connected to the same device bus or to another device bus.

As stated above, the system includes at least one computer readable medium. Examples of computer readable media are compact discs 1119, hard disks 1112, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer 1100 and for enabling the computer to interact with a human user. Such software may include, but is not limited to, device drivers, operating systems and user applications, such as development tools.

Thus, a computer program produce of the preset invention including storing program instructions for performing the inventive method is herein disclosed. The program instructions may include computer code devices which can be any interpreted or executable code mechanism, including but not limited to, scripts, interpreters, dynamic link libraries, Java classes, and complete executable programs. Moreover, parts of the processing of the present invention may be distributed for better performance, reliability, and/or cost.

The invention may also be implemented by the preparation of application specific integrated circuits or by interconnecting an appropriate network of conventional component circuits, as will be readily apparent to those skilled in the art. Numerous modifications and variations of the present invention are possible in light of the above teaching. It is therefore to be understood that within the scope of the appended claims, the invention may be practiced otherwise than as specifically described herein.

1. A method for analyzing a protein sample, comprising:
determining an isoelectric point range for a peptide derived from the protein sample by dispersing the peptide into a dispersion medium having a viscosity greater than water;
obtaining a mass spectrum of the derived peptides; and
identifying the derived peptide based on the mass spectrum and the isoelectric point range of the derived protein.

2. A method for analyzing a protein sample, comprising:
determining an isoelectric point range for peptides derived from the protein sample;
obtaining a mass spectrum of the derived peptides;
determining from the mass spectrum a first set of peptide identifications for the peptides; and
filtering incorrect identifications from the first set of peptide identifications by removal from the first set those peptide identifications calculated to have isoelectric point values less than or greater than the isoelectric point range.

3. The method of claim 3, wherein determining an isoelectric point range comprises:
digesting the protein sample;
fractionating the peptides in the digested sample; and
performing isoelectric focusing on a peptide fraction of the digested protein sample.

4. The method of claim 3, wherein measuring the isoelectric point range comprises:
performing isoelectric focusing on the derived peptides.

5. The method of claim 3, wherein measuring the isoelectric point range comprises:
performing immobilized pH gradient isoelectric focusing on the derived peptides.

6. The method of claim 3, wherein measuring the isoelectric point range comprises:
disposing the digested protein sample into a dispersion medium having a viscosity equal to or greater than water.

7. The method of claim 3, wherein measuring the isoelectric point range comprises:
disposing the digested protein sample into a dispersion medium having a viscosity at least two times as great as water.

8. The method of claim 3, wherein measuring the isoelectric point range comprises:
disposing the digested protein sample into a dispersion medium having a viscosity at least four times as great as water.

9. The method of claim 3, wherein measuring the isoelectric point range comprises:
disposing the digested protein sample in urea as a dispersion medium.

10. The method of claim 3, wherein measuring the isoelectric point range comprises:
performing slab gel isoelectric focusing on the derived peptides.

11. The method of claim 3, wherein measuring the isoelectric point range comprises:
performing free flow electrophoresis on the derived peptides.

12. The method of claim 3, wherein measuring isoelectric point range comprises:
performing capillary electrophoresis separation on the derived peptides.

13. The method of claim 3, wherein obtaining a mass spectrum comprises:
performing a mass scan with at least one of a time-of-flight mass spectrometer, a quadrupole mass spectrometer, a Fourier transform ion cyclotron resonance mass spectrometer, an ion trap mass spectrometer, and a hybrid instrument.

14. The method of claim 3, wherein obtaining a mass spectrum comprises:
obtaining a tandem mass spectrum of the derived peptides.

15. The method of claim 3, wherein obtaining a mass spectrum comprises:
obtaining a mass spectrum of the derived peptides without collision dissociation of the derived peptides.

16. The method of claim 3, wherein determining from the mass spectrum a first set of peptide identifications comprises:
comparing the mass spectrum to known peptide mass fragmentation patterns.

17. The method of claim 3, wherein determining from the mass spectrum a first set of peptide identifications comprises:
calculating the isoelectric point value based on an arrangement of amino acids on the peptides identified in the first set.

18. The method of claim 3, wherein filtering incorrect identifications comprises:
determining isoelectric point values for each peptide in the first set of peptide identifications; and
eliminating from the first set of peptide identifications those peptide identifications having determined isoelectric point values less than or greater than the isoelectric point range.

19. The method of claim 3, wherein filtering incorrect identifications comprises:
assigning peptide identification scores to the peptide identifications, the peptide identification scores based on respective comparisons between the mass spectrum and known peptide fragmentation patterns;
determining a threshold value for the peptide identification scores; and
filtering from the first set of peptide identifications those identifications having peptide identification scores below the threshold value.

20. The method of claim 19, wherein assigning peptide identification scores comprises:
determining for the peptide identification scores correlation values correlating the mass spectrum to the known peptide fragmentation patterns.

21. The method of claim 19, wherein assigning peptide identification scores comprises:
determining for the peptide identification scores ion scores based on a probability of there being a random match to the mass spectrum.

22. The method of claim 19, wherein determining a threshold value comprises:
calculating to-be-filtered peptide signatures based on inverted or randomized amino acid sequences of the known peptide fragmentation patterns.

23. The method of claim 22, further comprising:
determining a second threshold value based on the isoelectric point range and a number of the to-be-filtered peptide signatures.

24. The method of claim 23, wherein determining a second threshold value comprises:
setting the second threshold value to include only one of the to-be-filtered peptide signatures below the first threshold value.

25. The method of claim 23, wherein determining a second threshold value comprises:
setting the second threshold value to include no more of the to-be-filtered peptide signatures than one percent of the peptide identifications below the first threshold value.

26. The method of claim 23, wherein determining a second threshold value comprises:
setting the second threshold value to include no more of the to-be-filtered peptide signatures than two percent of the peptide identifications below the first threshold value.

27. The method of claim 23, wherein determining a second threshold value comprises:
setting the second threshold value to include no more of the to-be-filtered peptide signatures than five percent of the peptide identifications below the first threshold value.

28. The method of claim 19, wherein determining a first threshold value comprises:
normalizing a peak peptide identification score of the first peptide identification scores by an average other peptide identification scores.

29. The method of claim 28, wherein normalizing a peak peptide identification score comprises:
dividing the peak peptide identification score by the average of other peptide identification scores close in magnitude to the peak peptide identification score.

30. The method of claim 29, wherein dividing the peak peptide identification score comprises:
dividing the peak peptide identification score by the average of at least three other peptide identification scores closest in magnitude to the peak peptide identification score.

31. The method of claim 29, wherein dividing the peak peptide identification score comprises:
dividing the peak peptide identification score by the average of at least six other peptide identification scores closest in magnitude to the peak peptide identification score.

32. The method of claim 29, wherein dividing the peak peptide identification score comprises:
dividing the peak peptide identification score by the average of at least nine other peptide identification scores closest in magnitude to the peak peptide identification score.

33. A method for analyzing a protein sample, comprising:
obtaining a mass spectrum of peptides;
comparing the mass spectrum of peptides against known peptide fragmentation patterns;
determining from the mass spectrum of the peptides a first set of peptide identifications for the peptides;
assigning to the peptide identifications peptide identification scores based on the respective comparisons between the mass spectrum and known peptide fragmentation patterns;
performing a statistical evaluation of the peptide identification scores;
determining a threshold value for the peptide identification scores based on the statistical evaluation; and
filtering from the first set of peptide identifications those identifications having peptide identification scores below the threshold value.

34. The method of claim 33, wherein determining a threshold value comprises:
normalizing a peak peptide identification score by an average of other peptide identification scores.

35. The method of claim 33, further comprising:
determining an isoelectric point range for peptides derived from the protein sample.

36. The method of claim 35, further comprising:
determining the threshold value based on the peptide identifications of peptides having isoelectric point values within the isoelectric point range.

37. The method of claim 33, wherein determining a first threshold value comprises:
normalizing a peak peptide identification score of the first peptide identification scores by an average of other peptide identification scores.

38. The method of claim 37, wherein normalizing comprises:
dividing the peak peptide identification score by the average of other peptide identification scores closest in magnitude to the peak peptide identification score.

39. The method of claim 38, wherein dividing the peak peptide identification score comprises:
dividing the peak peptide identification score by the average of at least three other peptide identification scores closest in magnitude to the peak peptide identification score.

40. The method of claim 38, wherein dividing the peak peptide identification score comprises:
dividing the peak peptide identification score by the average of at least six other peptide identification scores closest in magnitude to the peak peptide identification score.

41. The method of claim 38, wherein dividing the peak peptide identification score comprises:
dividing the peak peptide identification score by the average of at least nine other peptide identification scores closest in magnitude to the peak peptide identification score.

42. A computer readable medium storing program instructions, which when executed by a computer system causes the computer system to perform the steps of:
determining from a mass spectrum of a derived peptide a first set of peptide identifications for the peptides;
filtering incorrect identifications from the first set of peptide identifications by removal from the first set those peptide identifications calculated to have isoelectric point values less than or greater than an isoelectric point range.

43. The computer readable medium of claim 42, wherein program instructions are programmed to cause the computer system to perform the further step of:
determining the isoelectric point range for the derived peptides.

44. The computer readable medium of claim 42, wherein program instructions are programmed to cause the computer system to perform the further step of:
obtaining the mass spectrum of the derived peptide.

45. A computer readable medium storing program instructions, which when executed by a computer system causes the computer system to perform the steps of:
determining a mass of a derived peptide without fragmentation of the derived peptides; and
identifying the derived peptide based on the mass of the derived peptide and an isoelectric point of the derived peptide.

46. The computer readable medium of claim 45, wherein program instructions are programmed to cause the computer system to perform the further step of:
determining the isoelectric point range for the derived peptide.

47. The computer readable medium of claim 45, wherein program instructions are programmed to cause the computer system to perform the further step of:
obtaining the mass spectrum of the derived peptide.

48. A computer readable medium storing program instructions, which when executed by a computer system causes the computer system to perform the steps of:
obtaining a mass spectrum of peptides;
comparing the mass spectrum of peptides against known peptide fragmentation patterns;
determining from the mass spectrum of the peptides a first set of peptide identifications for the peptides;
assigning peptide identification scores, to the peptide identifications, based on respective comparisons between the mass spectrum and known peptide fragmentation patterns;
performing a statistical evaluation of the peptide identification scores;
determining a threshold value for the peptide identification scores based on the statistical evaluation; and
filtering from the first set of peptide identifications those identifications having peptide identification scores below the threshold value.

49. The computer readable medium of claim 48, wherein program instructions are programmed to cause the computer system to perform the further step of:
obtaining the mass spectrum of the derived peptide.

50. The computer readable medium of claim 48, wherein program instructions are programmed to cause the computer system to perform the further step of:
normalizing a peak peptide identification score by an average of other peptide identification scores.

51. The computer readable medium of claim 48, further comprising:
determining the threshold value based on the peptide identifications of peptides having isoelectric point values within a determined isoelectric point range.

52. A system for analyzing a protein sample, comprising:
an isolectric point determination device configured to determine an isoelectric point range for a derived peptide of the protein sample;
a mass analyzer configured to analyze a mass spectrum from the derived peptide of the protein sample;
a comparator configured to compare the mass spectrum to known peptide fragmentation patterns to determine a first set of peptide identifications for the peptides; and
a filter device configured to filter incorrect identifications from the first set of peptide identifications by removal from the first set those peptide identifications calculated to have isoelectric point values less than or greater than the isoelectric point range.

53. A system for analyzing a protein sample, comprising:
an isolectric point determination device configured to determine an isoelectric point value for a derived peptide of the protein sample;
a mass analyzer configured to analyze a mass spectrum from the derived peptide of the protein sample;
a peptide identifier configured to identify the derived peptide based on the mass and the isoelectric point value of the derived peptide.

54. A system for analyzing a protein sample, comprising:
an isolectric point determination device configured to determine an isoelectric point range for a derived peptide of the protein sample by dispersion of the derived peptide into a dispersion medium having a viscosity greater than water;
a mass analyzer configured to analyze a mass spectrum from the derived peptide of the protein sample;
a peptide identifier configured to identify the derived peptide based on the mass spectrum and the isoelectric point range of the derived peptide.

55. A system for analyzing a protein sample, comprising:
a mass analyzer configured to analyze a mass spectrum from the derived peptide of the protein sample;
a comparator configured to compare the mass spectrum to known peptide fragmentation patterns to determine a first set of peptide identifications for the peptides and to assign to the peptide identifications peptide identification scores based on the respective comparisons between the mass spectrum and known peptide fragmentation patterns;
a filter device configured to determine a threshold value for the peptide identification scores by a statistical evaluation of the peptide identification scores, and to filter from the first set of peptide identifications those identifications having peptide identification scores below the threshold value.

56. The system of claim 55, wherein filter device is configured to filter from the first set of peptide identifications those identifications outside a determined isoelectric point value.
